(19) United States
(12) Patent Application Publication
(10) Pub. No.: US 2008/0028192 A1
(43) Pub. Date: Jan. 31, 2008

(54) Data processing apparatus, and data processing method

(75) Inventor: Hideki Sugimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/882,001

(22) Filed: Jul. 30, 2007

(30) Foreign Application Priority Data
Jul. 31, 2006 (JP) 2006/208106

(51) Int. Cl. G06F 9/30

(52) U.S. Cl. 712/215

(57) ABSTRACT

The present invention provides a data processing apparatus includes a plurality of register units and an operation unit. Each of the plurality of register units includes a register divided into a plurality of blocks, each of the plurality of blocks capable of holding a block data being at least 1 bit length. The operation unit sequentially reads the plurality of block data from at least one of the plurality of register units, performs predetermined operation, and outputs an operation result in units of blocks. At least one of the plurality of register units inputs a data having a plurality of block data in units of blocks and outputs the data to the operation unit in units of blocks before filling the register with full of the input data.

### BACKGROUND OF THE INVENTION

1. Field of the Invention

The present invention relates to a data processing apparatus and a data processing method. More specifically, the present invention relates to a data processing apparatus and a data processing method, for dividing data to process the divided data in a serial manner.

2. Description of the Related Art

In recent years, in order to satisfy necessity for processing a large amount of information, development of high-speed information processing techniques have been progressed. To improve information processing speeds, there are some possibilities that data processing operations are carried out in a serial manner, so that resultant processing times may be reduced. In other words, there are certain possibilities that circuit arrangements are made simple so as to shorten cycle times.

Operation apparatuses for performing the above-described serial operations have been disclosed in, for instance, JP 2004-318670 A. The disclosed operation apparatus includes a first parallel-to-serial converting circuit, a second parallel-to-serial converting circuit, a serial operation unit, and a serial-to-parallel converting circuit. The first parallel-to-serial converting circuit divides first parallel data into a predetermined number of first partial data, each of these first partial data is constituted by a predetermined number of bits, and the first parallel-to-serial converting circuit sequentially supplies the predetermined number of first partial data one by one. The second parallel-to-serial converting circuit divides second parallel data into a predetermined number of second partial data, each of these second partial data is constituted by a predetermined number of bits, and the second parallel-to-serial converting circuit sequentially supplies the predetermined number of second partial data one bygone. The serial operation unit sequentially executes operations a plurality of times equal to the predetermined number for every partial data with respect to both the predetermined number of first partial data which are sequentially supplied and the predetermined number of second partial data which are sequentially supplied. The serial-to-parallel converting circuit sequentially receives a predetermined number of operation results from the operation unit, and couples these received results with each other, and then, outputs the coupled result as third parallel data.

In such the operation apparatus, operation source data and operation target data are read and written in units of words. Therefore, data are parallel/serial-converted, and also, are serial/parallel-converted before and after the operation unit. As a result, the serial-to-parallel converting operation is not commenced until the operations by the operation unit are accomplished, so that operation latency is prolonged, and thus, processing performance is deteriorated. Therefore, the present invention is to provide an operation apparatus capable of reducing operation latency.

### SUMMARY

In one embodiment of the present invention, a data processing apparatus includes a plurality of register units and an operation unit. Each of the plurality of register units includes a register divided into a plurality of blocks, each of the plurality of blocks capable of holding a block data being at least 1 bit length. The operation unit sequentially reads the plurality of block data from at least one of the plurality of register units, performs predetermined operation, and outputs an operation result in units of blocks. At least one of the plurality of register units inputs a data having a plurality of block data in units of blocks and outputs the data to the operation unit in units of blocks before filling the register with full of the input data.

In another embodiment of the present inventions a data processing method is provided with inputting a data comprising a plurality of block data to one of a plurality of registers, sequentially reading the plurality of block data from the register in units of blocks, and performing predetermined operations for the plurality of block data and outputting the operation result in units of blocks before filling the register with full of the input data.

In accordance with the present invention, the operation apparatus capable of reducing operation latency can be provided. Also, according to the present invention, the operation apparatus capable of improving processing performance can be provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram for schematically showing a configuration of a data processing apparatus according to an embodiment of the present invention.

FIG. 2 is a block diagram for schematically showing a configuration of a data processing unit employed in the data processing apparatus of the embodiment.

FIG. 3 is a block diagram for showing a structure of a register file employed in the data processing apparatus.

FIG. 4 is a block diagram for showing a configuration of a register unit provided in the data processing apparatus.

FIG. 5 is a timing chart (1) for describing operations of the register file provided in the data processing apparatus.

FIG. 6 is a timing chart (2) for describing operations of the register file provided in the data processing apparatus.

FIG. 7 is a timing chart (3) for describing operations of the register file provided in the data processing apparatus.

FIG. 8 is a diagram for describing a circuit which reads out 1-bit data from a register employed in the data processing apparatus.

FIG. 9 is a diagram for describing a circuit which reads out plural-bit data from the register provided in the data processing apparatus.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

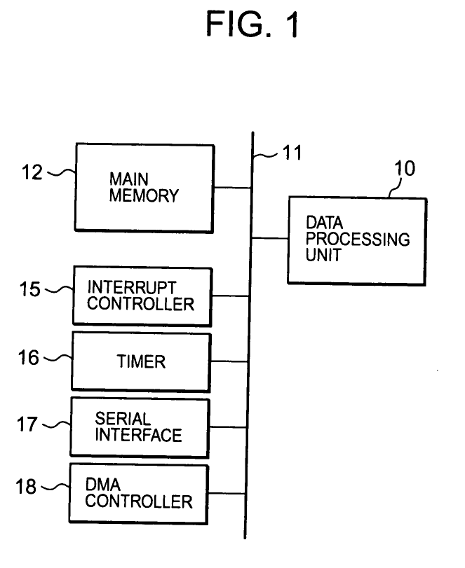

It should be noted that a serial operation described in the present embodiment is not limited only to an operation executed in units of 1 bit. For example, the serial operation includes an operation performed with respect to data in units of blocks each having a length equal to or larger than 1 bit and shorter than a word length of the data. FIG. 1 shows a schematic configuration of a data processing apparatus according to the present invention. The data processing apparatus includes a data processing unit 10, a main memory 12, an interrupt controller 15, a timer 16, a serial interface 17, and a DMA (Direct Memory Access) controller 18. These structural elements are connected to each other via a system bus 11. The data processing unit 10 processes data which is stored in the main memory 12, and data which is captured from the serial interface 17 based upon a program code which is stored in the main memory 12, and then, outputs the processed data to either the main memory 12 or the serial interface 17. The DMA controller 18 controls a data transfer operation between the main memory 12 and an input/output unit such as the serial interface 17, or a data transfer operation performed within the main memory 12 instead of the data processing unit 10. The timer 16 executes a time counting operation, and notifies an elapse of time via the interrupt controller 15 to the data processing unit 10. The interrupt controller 15 controls interrupts which are issued by the timer 16, the serial interface 17, the DMA controller 18, and the like, and then, notifies the interrupts to the data processing unit 10.

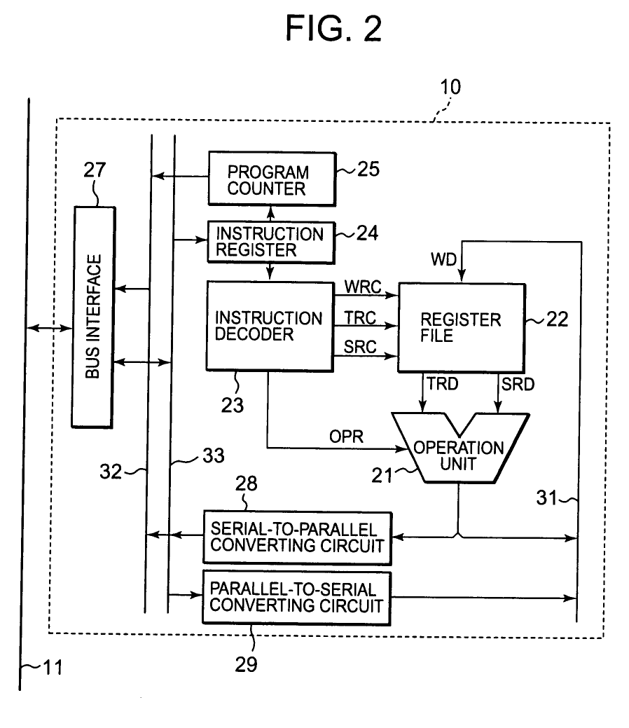

FIG. 2 is a block diagram for indicating a configuration of the data processing unit (CPU) 10. The data processing unit 10 includes an operation unit 21, a register file 22, an instruction decoder 23, an instruction register 24, a program counter 25, a bus interface 27, a serial-to-parallel converting circuit 28, and a parallel-to-serial converting circuit 29. The bus interface 27 connects the system bus 11 with an internal address bus 32 and an internal data bus 33. The internal address bus 32 is connected via the program counter 25 and the serial-to-parallel converting circuit 28 to the operation unit 21. A program address indicated by the program counter 25, or a data address calculated by the operation unit 21 is outputted from the internal address bus 32 via the bus interface 27 to the system bus 11.

An instruction code supplied from the system bus 11 via the bus interface 27 is stored through the internal data bus 33 to the instruction register 24. The instruction code stored in the instruction register 24 is decoded by the instruction decoder 23, so the signals for controlling the operation unit 21 and the register file 22 are generated. The instruction register 24 outputs, for example, a jumping destination address contained in an instruction code to the program counter 25. The program counter 25 increments an address of a program to be executed and holds the incremented address, or holds a jumping destination address supplied from the instruction register 24.

The instruction decoder 23 outputs an operation type indication signal “OPR” which indicates a type of an operation to the operation unit 21, based upon an instruction code stored in the instruction register 24. The instruction decoder 23 outputs a write register control signal “WRC” (including “WS” and “WRN”), an operation target register control signal “TRC” (including “TRR” and “TRN”), and an operation source register control signal “SRC” (including “SRR” and “SRN”) to the register file 22. The register file 22 outputs data “TRD” which is stored in the indicated register to the operation unit 21 in a serial manner, based upon the operation target register control signal TRC. Also, the register file 22 outputs data “SRD” of the indicated register to the operation unit 21 in a serial manner, based upon the operation source register control signal SRC. Furthermore, the register file 22 stores an operation result “WD” which is outputted from the operation unit 21 in a serial manner via a register write bus 31 to the indicated register, based upon the write register control signal WRC. The operation unit 21 performs an operation indicated by the operation type indication signal OPR with respect to data inputted from the register file 22. An operation result is outputted to the register write bus 31 and the serial-to-parallel converting circuit 28. The serial-to-parallel converting circuit 28 converts operation results which are outputted from the operation unit 21 in a serial manner into parallel data, and then, outputs these parallel data to the internal data bus 33 and the internal address bus 32. The parallel-to-serial converting circuit 29 captures the parallel data outputted to the internal data bus 33, and converts the captured parallel data to serial data, and then outputs the converted serial data to the register write bus 31.

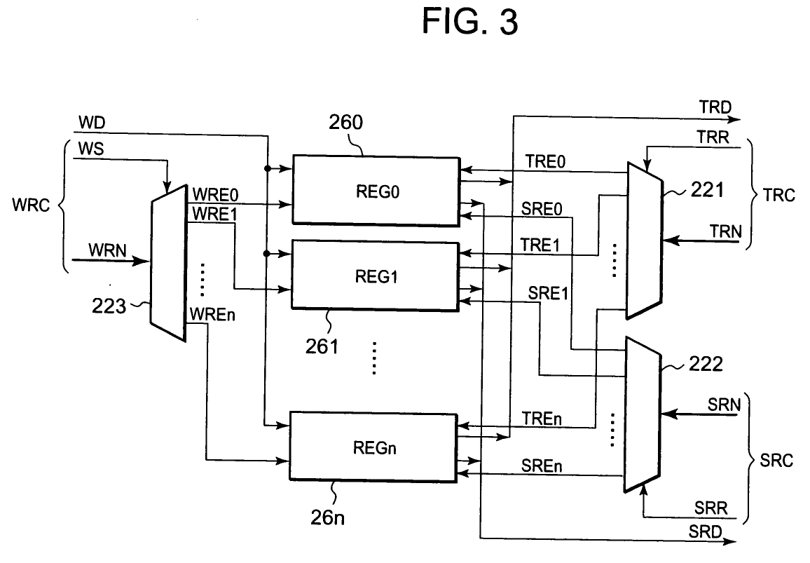

FIG. 3 is a block diagram for indicating a configuration of the register file 22. The register file 22 is provided with register units 260 to 26n, a target register number decoder 221, a source register number decoder 222, and a write register number decoder 223.

The target register number decoder 221 decodes an entered target register number “TRN” so as to output target register read enable signals “TRF0” to “TRFn” in synchronism with a target register read signal “TRR.” The source register number decoder 222 decodes an entered source register number “SRN” so as to output source register read enable signals “SRE0” to “SREn” in synchronism with a source register read signal “SRR.” The write register number decoder 223 decodes an entered write register number “WRN” so as to output write enable signals “WRE0” to “WREn” in synchronism with a write signal “WS”.

The register units 260 to 26n selected based upon the write enable signals WRE0 to WREn capture the write data WD which are transferred via the register write bus 31 in a serial manner to store the captured write data WD there into. The register units 260 to 26n selected based upon the target register read enable signals TRE0 to TREn, and the source register read enable signals SRE0 to SREn output target register read data TRD and source register read data SRD to the operation unit 21 in a serial manner, respectively.

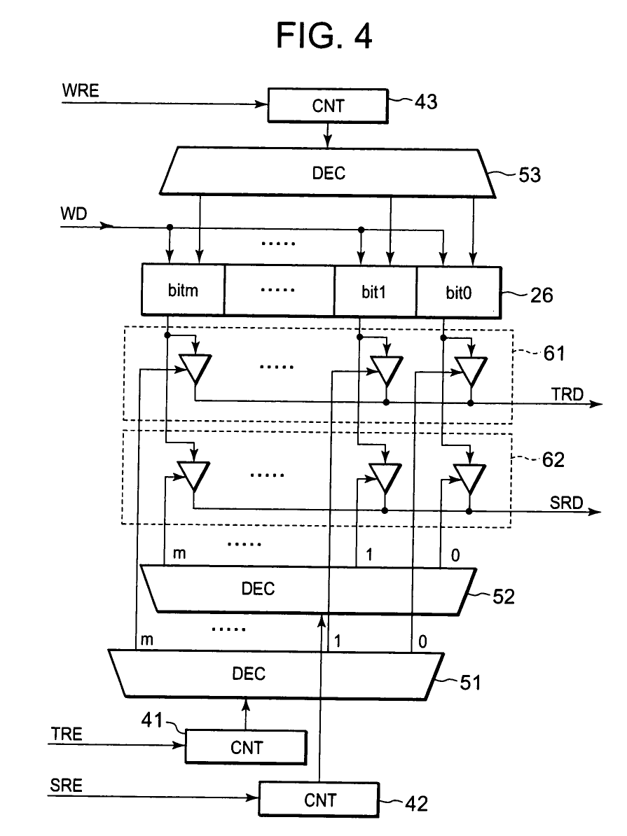

As shown in FIG. 4, each of the register units 260 to 26n includes a register 26, a target read bit counter 41, a source read bit counter 42, a write bit counter 43, a target read bit decoder 51, a source read bit decoder 52, a write bit decoder 53, a target read data selecting circuit 61, and a source read data selecting circuit 62.

The register 26 capable of storing there into data constructed of “m” bits stores write data WD which are transferred in a serial manner into designated bit positions in units of 1 bit. The register 26 reads the stored m-bit-data in a parallel manner, and outputs the read m-bit data to the data selecting circuits 61 and 62.

The write bit counter 43 corresponds to a binary counter which is counted up every clock by being triggered by the write enable signal WRE. In other words, the write bit counter 43 counts write bit positions of the register 26 from “0” to “m.” Based upon a count value of the write bit counter 43, the write bit decoder 53 outputs a signal for designating a write bit position of the register 26.

The target read bit counter 41 corresponds to a binary counter which is counted up every clock by being triggered by the target register read enable signal TRE. In other words, the target read bit counter 41 counts bit positions read from the register 26 from “0” to “m.” Based upon a count value of the target read bit counter 41, the target read bit decoder 51 outputs a signal for designating a bit position read from the register 26 to the target read data selecting circuit 61.

The source read bit counter 42 corresponds to a binary counter which is counted up every clock by being triggered by the source register read enable signal SRE. In other words, the source read bit counter 42 counts bit positions read from the register 26 from “0” to “m.” Based upon a count value of the source read bit counter 42, the source read bit decoder 52 outputs a signal for designating a bit position read from the register 26 to the source read data selecting circuit 62.

The target read data selecting circuit 61 selects 1 bit of data, which is outputted from the register 26, based upon a signal outputted from the target read bit decoder 51, and outputs the selected data. Since the target read bit counter 41 counts up the bit position, a read position is shifted in units of 1 bit. Therefore, the target read data selecting circuit 61 outputs the data stored in the register 26 in a serial manner as the target register read signal TRD.

The source read data selecting circuit 62 selects data by 1 bit, which is outputted from the register 26, based upon a signal outputted from the source read bit decoder 52, and outputs the selected data. Every time the source read bit counter 42 counts up the bit position, a read position is shifted in units of 1 bit. Therefore, the source read data selecting circuit 62 outputs the data stored in the register 26 in a serial manner as the source register read signal SRD.

As described above, each of sets made from counters and decoders has been arranged in such a manner that the respective counter/decoder sets can be independently operated. Therefore, the same register 26 may be designated by a target register and a source register. Also, writing operations and reading operations may be performed at respective timing. In other words, the respective sets made from the counters and the decoders may be alternatively operated in parallel modes within a consistent range.

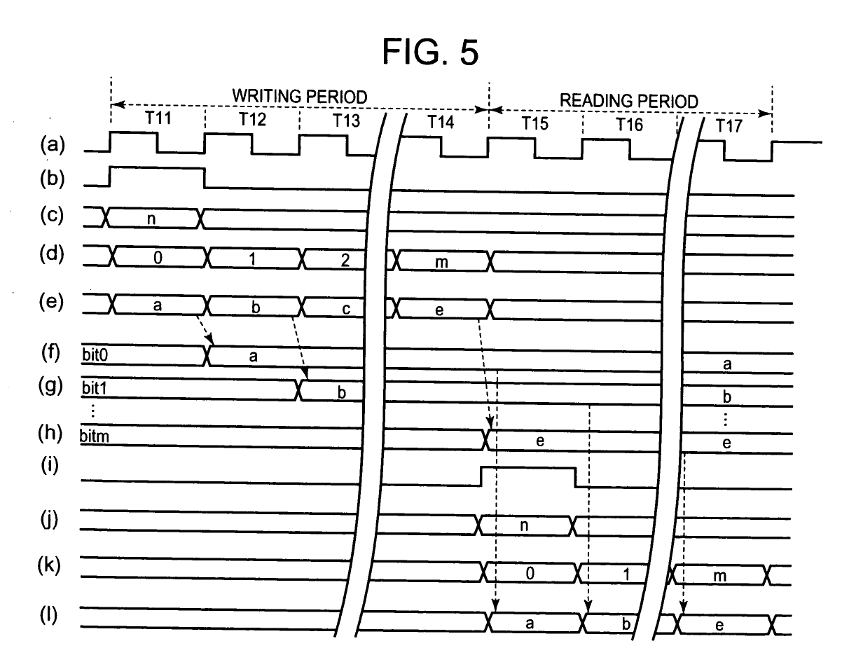

Next, a description is made of data wiring/reading operations of the register file 22. First, a description is made of an operation that data is written in the register file 22, and the written data is read therefrom with reference to FIG. 5.

FIG. 5(a) represents a clock signal indicating timing of data read and data write with symbols applied to clock cycles of the clock signal. Hereinafter, the timing will be described based upon these clock cycles. The timing at which data is written in the register 26 is indicated by clock cycles T11 to T14, whereas the timing at which data is readout from the register 26 is indicated by clock cycles T15 to T17.

In order to store data in the register file 22, parallel data is converted to serial data, and the serial data is stored via a register write bus to a designated register. Therefore, write data (FIG. 5(e)) which is transferred in synchronism with the clock signal (FIG. 5(a)) is stored at a bit position of the register 26 corresponding to an output (FIG. 5(d)) of the write bit counter 43 (FIG. 5(f) to FIG. 5(h)).

When the writing operation is commenced, the write signal WS is inputted to the write register number decoder 223 in combination with the write register number WRN (FIG. 5(c)) at a timing indicated in FIG. 5(b). In this decoder 223, “n” is designated as a write register number. Therefore, the write register number decoder 223 outputs the write enable signal WREn at the timing indicated in FIG. 5(b) with respect to the register unit 26n.

The write bit counter 43 commences a counting operation by receiving the write enable signal WREn as a trigger signal. As shown in FIG. 5(d), the write bit counter 43 is reset to “0” in the clock cycle T11, and is incremented to “1” in the clock cycle T12, and also, is incremented to “2” in the clock cycle T13, and then, the count value thereof becomes a maximum value “m” in the clock cycle T14.

The write data WD is inputted via the register write bus 31 to the register unit 26n in synchronism with the clock signal (FIG. 5(a)). Data “a” of a least significant bit (LSB) is inputted to the register unit 26n in the clock cycle T11, data “b” of a bit 1 is inputted thereto in the clock cycle T12, data “c” of a bit 2 is inputted thereto in the clock cycle T13, data “e” of a most significant bit (bit “m”) is inputted thereto in the clock cycle T14, and then, these data “a”, “b”, %“c”, . . . , “e” are stored at designated bit positions of the register unit 26n, respectively (FIG. 5(f) to FIG. 5(h)).

In the clock cycles T15 to T17 corresponding to a reading period, first of all, in the clock cycle T15, both the target register read signal TRR and the source register read signal SRR, which designate registers from which data are read, are applied to the register file 22 in combination with a register number “n” (FIG. 5(i) and FIG. 5(j)). The register number “n” is decoded; both the target register enable signal TREn and the source register enable signal SREn are outputted to the register unit 26n at such a timing as shown in FIG. 5(i); and both the target read bit counter 41 and the source read bit counter 42 commence counting operations (FIG. 5(k)). The data (FIG. 5(f) to FIG. 5(h)) which are held in the register 26 of the register unit 26n are sequentially outputted to the operation unit 21 from the bit “0” to the bit “m” in synchronism with the clock signal (FIG. 5(l)).

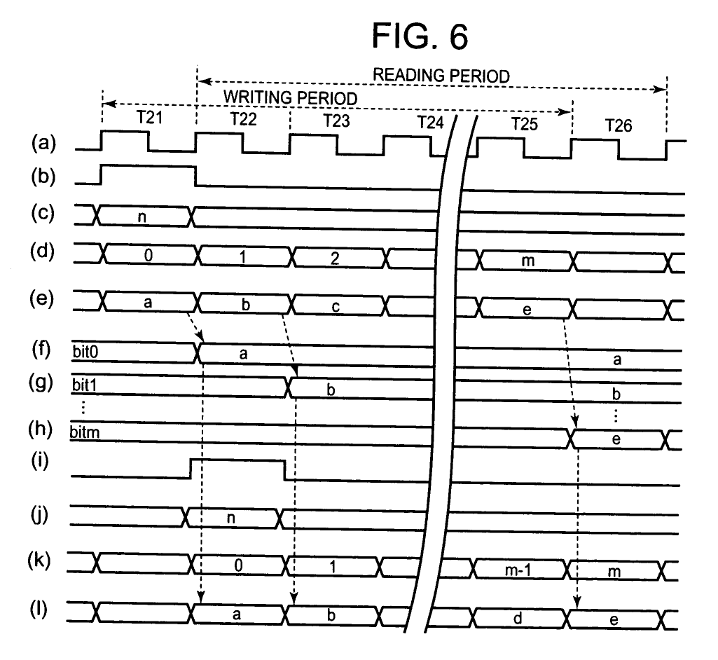

Next, reading operations immediately after a register writing operation will now be described with reference to FIG. 6. Register writing timing is identical to the above-described timing shown in FIG. 5. Therefore, the write signal WS is inputted to the write register number decoder 223 in combination with the write register number WRN (FIG. 6(c)) at a timing indicated in FIG. 6(b). In this decoder 223, “n” is designated as a write register number. Therefore, the write register number decoder 223 outputs the write enable signal WRE at the timing indicated in FIG. 6(b) with respect to the register unit 26n.

The write bit counter 43 commences a counting operation by receiving the write enable signal WRE as a trigger signal. As shown in FIG. 6(d), the write bit counter 43 is reset to “0” in the clock cycle T21, and is incremented to “1” in the clock cycle T22, and also, is incremented to “2” in the clock cycle T23, and then, the count value thereof becomes a maximum value “m” in the clock cycle T25.

The write data WD is inputted via the register write bus 31 to the register unit 26n in synchronism with the clock signal (FIG. 6(a)). Data “a” of a least significant bit (LSB) is inputted to the register unit 26n in the clock cycle T21, data “b” of a bit 1 is inputted thereto in the clock cycle T22, data “c” of a bit 2 is inputted thereto in the clock cycle T23, data “e” of a most significant bit (bit “m”) is inputted thereto in the clock cycle T25, and then, these data “a”, “b”, “c”, . . . , “e” are stored at designated bit positions of the register unit 26n (FIG. 6(f) to FIG. 6(h)).

A data reading operation from a register is commenced, which is delayed by 1 clock cycle from the commencement of the writing operation. In the clock cycle T22, the register read signals (TRR and SRR) are applied to the register file 22 in combination with the register numbers “n” (TRN and SRN) (FIG. 6(i) and FIG. 6(j)). The register numbers “n” are decoded, so that the register read enable signals (TREn and SREn) are outputted to the register unit 26n at a timing shown in FIG. 6(i). Then, the read bit counters (41 and 42) commence counting operations (FIG. 6(k)). The data (FIG. 6(f) to FIG. 6(h)) which are held in the register 26 of the register unit 26n are sequentially outputted to the operation unit 21 in a serial manner from the bit “0” up to the bit “m” in synchronism with the clock signal. That is to say, the data at the bit positions just after these data have been written into the register 26 are sequentially read (FIG. 6(l)).

Although the description has been made of the data processing unit including one operation unit, the present invention may be alternatively applied to another data processing unit including a plurality of operation units. In the case where the data processing unit is provided with the plurality of operation units, when an operation result of a first block outputted from a first operation unit is written in a register, this first block is read without waiting definitions of operation results about all of blocks, so an operation of a second operation unit can be commenced. A delay from starting of the operation of the first operation unit until starting of the operation of the second operation unit corresponds to only an operating time of the first block. As described above, in the register file 22, the reading operation with respect to the register 26 is carried out while the LSB of the data is employed as a reference, and the reading operation is executed such that the reading operation is overlapped with the writing operation. As a result, latency that occurs, when either a serial operation processing or an operation in units of blocks is carried out, can be reduced, so an improvement of processing performance can be realized.

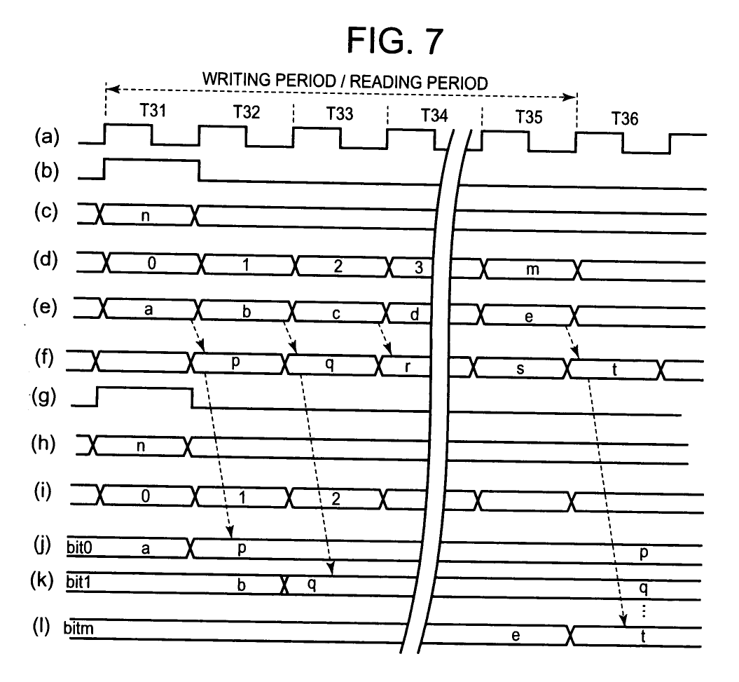

Referring to FIG. 7, a description is made of writing operations immediately after a reading operation. A symbol is applied every time period of a clock signal (FIG. 7(a)), and timing is described by employing this symbol. Since a target register reading operation and a source register reading operation are carried out at the same timing, the target register reading operation will now be described in this embodiment.

The target register read signal TRR is entered to the read register number decoder 221 in combination with the target register number TRN in a clock cycle T31 (FIG. 7(b) and FIG. 7(c)). In this decoder 221, symbol “n” is designated as a target register read register number. Therefore, the target register read number register 221 outputs the target register read enable signal TREn to the register unit 26n at a timing indicated in FIG. 7(b).

The target read bit counter 41 commences a counting operation by receiving the target register read enable signal TREn as a trigger signal. As indicated in FIG. 7(d), the target read bit counter 41 is reset in the clock cycle T31, and is incremented to “1” in the clock cycle T32, and also, is incremented to “2” in the clock cycle T33, and then, the count value thereof becomes a maximum value “m” in the clock cycle T35.

In synchronism with this operation, the target register read data TRD is outputted from the register unit 26n. In other words, data “a” of a bit “0” in the clock cycle T31, data “b” of a bit 1 in the clock cycle T32, data “c” of a bit 2 in the clock cycle T33, . . . , data “e” of a bit “m” in the clock T35 are sequentially supplied to the operation unit 21 (FIG. 7 (e)). As to the target register read data TRD, designated operations are carried out every bit in the operation unit 21, and then, the processed bit data are sequentially outputted (FIG. 7(f)). That is to say, operation results “p”, “q”, . . . , “t” are outputted before data of the next bit is supplied to the operation unit 21.

On the other hand, the write signal WS is inputted to the write register number decoder 223 in combination with the write register number WRN (FIG. 7 (h)) at a timing indicated in FIG. 7(g)). In this decoder 223, it is so assumed that symbol “n”, which is equal to the target register number, is designated as a write register number. The write register number decoder 223 outputs the write enable signal WREn at the timing indicated in FIG. 7(g) with respect to the register unit 26n.

The write bit counter 43 commences a counting operation by receiving the write enable signal WREn as a trigger signal. The write bit counter 43 is reset to “0” in the clock cycle T31, and is incremented to “1” in the clock cycle T32, and also, is incremented to “2” in the clock-cycle T33, and then, the count value thereof becomes a maximum value “m” in the clock cycle T35. A value of the write bit counter 43 is decoded by the write bit decoder 53, and the decoded value designate a write bit position of a write register. Operation results (FIG. 7(f)) outputted from the operation unit 21 are sequentially stored in designated bit positions (FIG. 7(j) to FIG. 7(l)). In this case, since the target register and the write register belong to the same register unit 26n, “a” is replaced with “p” in the bit “0” of the register unit 26n; “b” is replaced with “q” in the bit “1” thereof; . . . , “e” is replaced with “t” in the bit “m” thereof, namely replaced by data after operation.

As described above, in the register file 22, the writing operation with respect to the register 26 is carried out while the LSB of the data is employed as a reference, and the writing operation is executed such that the reading operation is overlapped with the reading operation. As a result, latency that occurs, when either a serial operation processing or an operation in units of blocks is carried out, can be reduced, so improvement of processing performance can be realized.

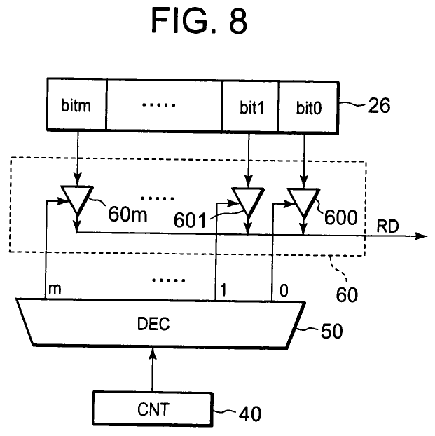

In the above-described embodiment, the data are read from the register file 22 in units of 1 bit and the data are written in the register file 22 in units of 1 bit. For example, as represented in FIG. 8, a data reading circuit for reading data from the register 26 is operated as follows: data outputted from the register 26 are read, and the read data are selected in units of 1 bit by a read data selecting circuit 60, and then, the selected bit data is outputted in a serial manner. A bit position to be outputted is counted by a bit counter 40. A count value is decoded by a bit position decoder 50, and then, the decoded count value is outputted to the read data selecting circuit 60. In the read data selecting circuit 60, an output data of a buffer “60i” at a designated position among buffers 600 to 60m becomes valid in response to a bit selecting signal outputted from the bit position decoder 50, and then, the output data of this buffer “60i” is outputted as serial data.

A data writing operation to the register 26 is carried out in a similar manner. That is, a write enable signal is outputted to a flip-flop which corresponds to each of the bits of the register 26. As a result, the data is written only in such a flip-flop of a bit designated by this write enable signal. Accordingly, serial data may be sequentially written in the respective flip-flops of the register 26.

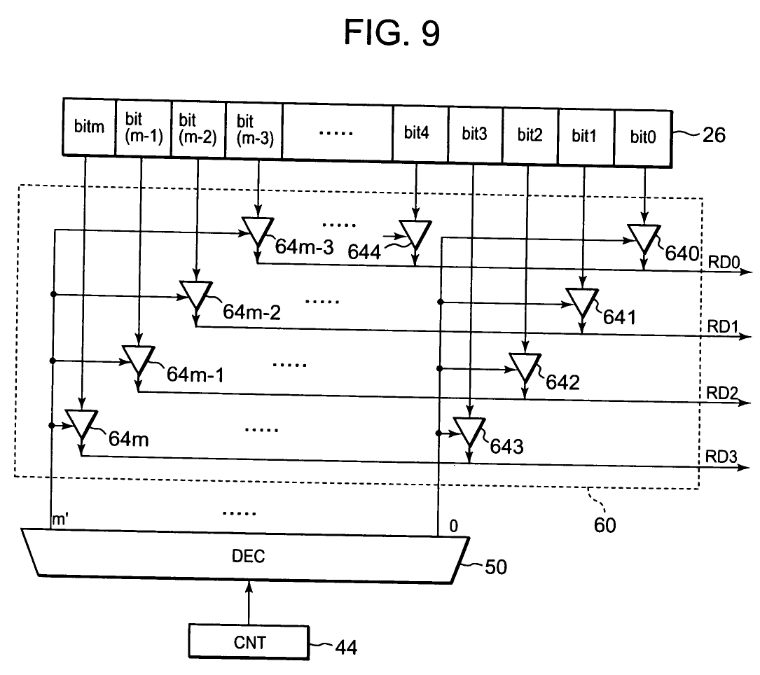

Alternatively, the above-described reading and writing operation may be carried out with respect to each block having multiple bits. That is, when the operation unit 21 performs operations for data divided every block having a plurality of bits in a serial manner, the operation unit 21 may read the data from the register file 22 every block and may write the read data in the register file 22 every block. For example, as shown in FIG. 9, a circuit which reads data by dividing the data in units of 4 bits is provided with a counter 44, a decoder 54, and a read data selecting circuit 64, which is similar to those of 1 bit. The counter 44 counts reading positions of the register 26 in units of 4 bits. The decoder 54 decodes the reading positions in units of 4 bits. The read data selecting circuit 64 selects data in units of 4 bits.

Block positions to be outputted are counted by the counter 44. The count values are decoded by the decoder 54, and then, the decoded count values are outputted to the read data selecting circuit 64. In the read data selecting circuit 64, output data of 4 buffers “64i” to “64(i+3)” at the designated positions among the buffers 640 to 64m become valid in response to a block selecting signal outputted from the decoder 54, and then, the valid output data are outputted as serial data of “RD0” to “RD3.” A data writing operation to the register 26 is carried out in a similar manner. That is, a write enable signal is outputted to a flip-flop which corresponds to each of the blocks of the register 26. As a result, the data is written only in such a flip-flop of a block designated by this write enable signal. Accordingly, serial data which are supplied in units of blocks may be sequentially written in the respective flip-flops of the register 26 in units of 4 bits.

As described above, the data are read from the register file 22 in units of blocks, and the operation is performed for the read data in units of blocks, and then, the resulting data are stored in the register file 22, or the serial-to-parallel converting circuit 28 in units of blocks. With respect to this operation, since the number of bits is increased, a total number of operations in units of blocks is decreased; and if operation times of block units are equal to each other, then an overall operation time is decreased. However, when the number of bits for a block is increased, an operation time such as a carry is increased, so the number of bits for the block cannot be excessively increased. Therefore, desirably, the number of bits for the block is approximately 4 bits to 8 bits.

As described above, the normal operation can be carried out by processing these data from the data of the LSB side irrespective of the data of the MSB side. Therefore, all of the data to be used in the operation are handled in units of blocks each having a length equal to or larger than 1 bit and shorter than the word length of the data; when these data are transferred and operated, the LSB or the data block containing the LSB is firstly transferred, and operated. The LSB or the data block containing the LSB is firstly readout from the register file, and then, the read data block is supplied to the operation unit as the operation source data and the operation target data. The operation unit sequentially performs the operation processing with respect to the data from the data having the LSB, and then, rewrites the processed data in the register file as the operation result data. As a result, the latency occurred when the operation processing is carried out can be reduced, so the improvement in the processing performance can be realized. It should be noted that there is an arithmetic logical unit (ALU) which executes an arithmetical operation and a logical operation as a general example for the operation unit. However, the operation unit of the present invention is not limited to the ALU, but may be realized by, for instance, a floating point processing unit (FPU), or another operation unit which executes a data operation processing. In the embodiment of the present invention, the description has been made of the operation unit which processes the data from the LSB side, the operation unit may process the data from the MSB side in a similar manner. By carrying out the data process operation in a sequence adapted to a property of operation, it becomes possible to realize the improvement of processing performance.

1. A data processing apparatus, comprising:
a plurality of register units, each of which including a register divided into a plurality of blocks, each of the plurality of blocks capable of holding a block data being at least 1 bit length;
an operation unit sequentially reading the plurality of block data from at least one of the plurality of register units, performing predetermined operation, and outputting an operation result in units of blocks;
wherein at least one of the plurality of register units inputs a data having a plurality of block data in units of blocks and outputs the data to the operation unit in units of blocks before filling the register with full of the input data.

2. A data processing apparatus according to claim 1, wherein:
at least one of the plurality of register units sequentially inputs the operation result in units of blocks as the input data before the operation unit completes the predetermined operation for all the plurality of block data.

3. A data processing apparatus according to claim 1, wherein:
the operation unit sequentially reads the plurality of block data from the block data including a least significant bit (LSB) in the register.

4. A data processing apparatus according to claim 1, wherein:
the operation unit sequentially reads the plurality of block data from the block data including a most significant bit (MSB) in the register.

5. A data processing apparatus according to claim 1, wherein:
each of the plurality of register units comprises:
a first counter counting clock pulses;
a write block position decoder decoding a count value of the first counter to
designate a write block position of the register for the input block data;
a second counter counting clock pulses;
a read block position decoder decoding a count value of the second counter to
designate a read block position of the register; and
a selector selecting a read block data of the register designated by the read block
position decoder to output the read block data;
wherein writing the input block data into the write block position of the register and reading the read block data of the read block position of the register is independently executed.

6. A data processing apparatus according to claim 1, wherein:
a register among the plurality of registers, which is designated by a reading operation, is designated by a writing operation at the same time; and
immediately after the block data of the register is read by the reading operation, a new block data is written in the position where the block data has been read.

7. A data processing apparatus according to claim 1, wherein:
a register among the plurality of registers, which is designated by a writing operation, is also designated by a reading operation at the same time; and
a block data written by the writing operation is read out by the reading operation immediately after the writing operation is carried out.

8. A data processing apparatus according to claim 1, further comprising:
a parallel-to-serial converting circuit capturing a input data having a predetermined word length transferred via a first bus, converting the input data into block data in units of blocks, and supplying the converted block data to the register file via a second bus having the same bit width as the block data; and
a serial-to-parallel converting circuit capturing the block data in units of blocks outputted from the operation unit, converting the block data into data having the predetermined word length, and transferring the converted data to the first bus.

9. A data processing apparatus according to claim 1, wherein the block data comprises 1-bit data.

10. A data processing apparatus according to claim 1, wherein the block data comprises one of 4-bit data and 8-bit data.

11. A data processing apparatus according to claim 1, wherein the operation unit is a arithmetic logical unit(ALU).

12. A data processing apparatus according to claim 1, wherein the operation unit is a floating point processing unit(PFU).

13. A data processing apparatus according to claim 1, further comprising:
another operation unit sequentially reading a plurality of blocks from at least one of the plurality of register units, performing predetermined operation, and outputting an operation result in units of blocks.

14. A data processing method, comprising:
inputting a data comprising a plurality of block data to one of a plurality of registers;
sequentially reading the plurality of block data from the register in units of blocks; and
performing predetermined operations for the plurality of block data and outputting the operation result in units of blocks before filling the register with full of the input data.

15. A data processing method according to claim 14, further comprising:
sequentially inputting the operation result to at least one of the plurality of registers in units of blocks before the operation unit completes predetermined operations for all the plurality of block data.

16. A data processing method according to claim 14, wherein sequentially reading the plurality of block data from the block data including a least significant bit (LSB) in the register.

17. A data processing method according to claim 14, wherein sequentially reading the plurality of block data from the block data including a most significant bit (MSB) in the register.

18. A data processing method according to claim 14, wherein immediately after reading one of the plurality of block data from the register, inputting a new block data to the position in the register where the block data has been read.

19. A data processing method according to claim 14, wherein immediately after inputting one of the plurality of block data to one of the plurality of registers, reading the block data to perform predetermined operation.

20. A data processing apparatus, comprising:
a register file including a plurality of registers, each of the registers having a plurality of blocks each being one or more bits, and
an operation unit performing a predetermined operation on each of the blocks that are sequentially read out of at least one of the registers to produce an operation result,
the operation result on one of the blocks being written back to the register file while the predetermined operation being performed on a subsequent one of the blocks.
